(19) United States
(12) Patent Application Publication
(10) Pub. No.: US 2007/0018350 A1
(43) Pub. Date: Jan. 25, 2007

(54) Method of producing a part

(76) Inventors: Anthony Brant, Manitou Beach, MI (US); Robert J. Adams, Ypsilanti, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/517,834

(22) Filed: Sep. 8, 2006

Related U.S. Application Data
(63) Continuation-in-part of application No. 10/795,471, filed on Mar. 8, 2004.

(51) Int. Cl. B29C 33/40

(52) U.S. Cl. 264/219; 264/40.1; 264/328.1

(57) ABSTRACT

A method of producing a part is performed by initially defining a desired model of the part having a first configuration. The desired model is mathematically manipulated to provide a distorted model defining a second configuration that is different from the first configuration. A mold assembly is produced having a shape that corresponds with the second configuration. Material is applied to the mold assembly to produce a part having the second configuration. The part is then conformed to the first configuration corresponding to the desired model.

### CROSS-REFERENCE TO RELATED APPLICATIONS

This application is a continuation-in-part of U.S. patent application Ser. No. 10/795,471, filed on Mar. 8, 2004, the disclosures of which is incorporated herein by reference.

### BACKGROUND OF THE INVENTION

A shaped layer produced from plastic material has a number of uses and applications. A number of techniques are used for making the shaped layer. One such technique is heat shaping. In heat shaping, a thermoplastic material sheet is heated above its softening temperature and is distorted inside a mold. The mold used corresponds to a negative or positive impression of a desired pattern. The process may be applied using a vacuum action, mechanical means, or the like, for example. The heat-shaping process is limited to applications which involve non-complex forms and plastic materials with a relatively low softening point.

A second method is slush molding, which includes completely filling a cavity from a tray-like mold with a liquid or solid powdered plastic material. When the plastic material contacts the mold walls, the plastic material begins to form a film on the mold walls. The mold is then inverted to remove excess liquid plastic material. Once the film remaining in the mold has cooled, the film is stripped from the mold walls. Slush molding is a labor-intensive process which requires large amounts of energy and subjects the molds to undesirable heat impact, resulting in damage to the molds.

A third technique is gun spraying which includes spraying a liquid plastic material over a mold surface to form a solidified plastic film. Gun spraying eliminates some of the drawbacks of the other methods described. However, one limitation has been that the gun spraying can be used only when all the portions of the surface to be coated are easily accessible by the spray from the gun. Certain methods, such as turning a flexible mold inside out to make the inner surfaces more accessible, have been employed in an attempt to reduce of eliminate this limitation. Such a method is not generally suitable for flexible molds having a counter-taper, for example, where it becomes very difficult or impossible to return the mould to the original position. Additionally, repeated turning inside out wears out the flexible mold over time.

A fourth technique is injection molding, in which molten material is injected into a cavity of a mold assembly to form the shaped part. For the formation of complex shapes, intricate mold assemblies using a plurality of movable mold elements are generally necessary. Not only are these mold assemblies costly to manufacture, the injection molding operation may create a parting line onto the shaped part at locations where mold elements are positioned next to each other.

### SUMMARY OF THE INVENTION

A method of producing a part is disclosed. A desired model of the part is defined having a first configuration. The desired model is mathematically manipulated to provide a distorted model defining a second configuration that is different from the first configuration. A mold assembly is produced having a shape that corresponds with the second configuration. Material is applied to the mold assembly to produce a part having the second configuration. The part is then conformed to the first configuration corresponding to the desired model.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a flow diagram illustrating a method of producing a mold for producing a shaped layer by gun spraying and other molding techniques.

FIG. 2 is a flow diagram illustrating a production process using the mold produced according to the method of FIG. 1.

FIG. 3 is a perspective view of a part which may be produced by an injection molding process.

FIG. 4 is a cross-sectional view of the part taken along line 4-4 of FIG. 3.

FIG. 5 is a cross-sectional view of a portion of an injection mold assembly that can be used in producing the part illustrated in FIG. 3.

FIG. 6 is partial cross-sectional view of the mold assembly illustrated in FIG. 5 shown in an opened position.

FIG. 7 is a cross-sectional view of a portion of a trim panel incorporating the part of FIG. 3.

FIG. 8 is an elevational view of a portion of a portion of a door trim panel incorporating the trim panel of FIG. 7.

FIG. 9 is a partial cross-sectional view of an alternate embodiment of a part which may be produced by an injection molding process.

FIG. 10 is a cross-sectional view of a mold assembly used in producing the part of FIG. 9.

FIG. 11 is a cross-sectional view of the part illustrated in another configuration prior to being conformed to the desired first configuration of the part shown in FIG. 9.

### DETAILED DESCRIPTION OF THE PREFERRED EMBODIMENTS

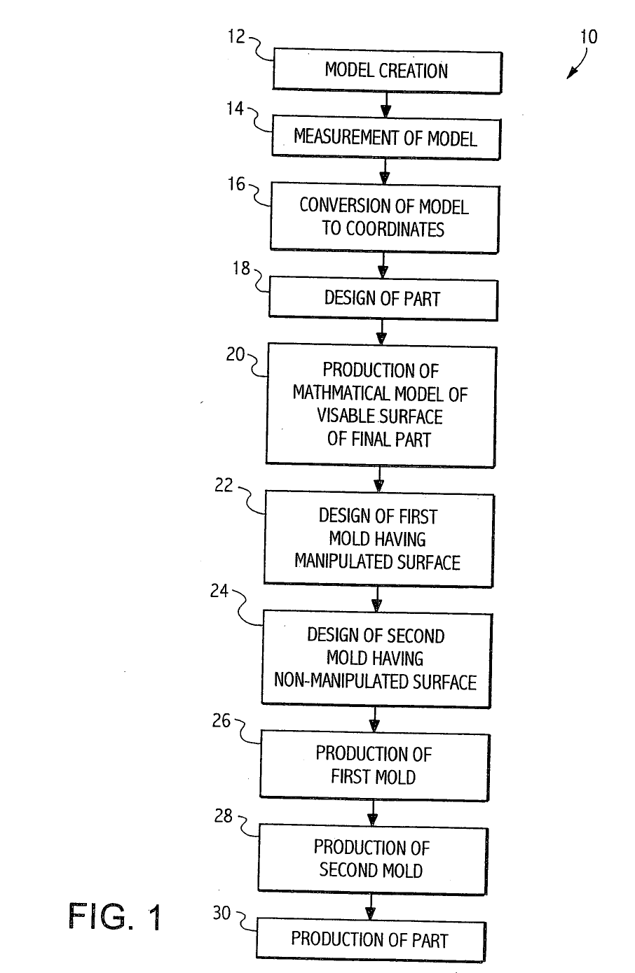

One embodiment of the invention relates to a method of preparing a shaped layer from a flexible plastic material from a particular pattern, shown generally at 10 in FIG. 1. The method of preparing a shaped layer 10 includes forming a layer of flexible plastic material on a shaping surface of a first mold which corresponds to a distorted pattern of a desired final shape. The distorted pattern of the final shape facilitates gun spraying, as well as other molding techniques, as surfaces of the final shape are visible on the surface of the distorted pattern. The layer of flexible plastic is then stripped from the first mold and disposed on a second mold. A shaping surface of the second mold coincides with the desired final shape. The method of distorting the first mold by this invention may be accomplished by the distorting of a mathematical or computer model which represents the final shape.

The method for producing a shaped layer 10 may include a first step of creating a physical model 12 of the desired final shape of a part having a first configuration. Typically, the model is created from clay to provide a representation of the desired final shape which is accurate in both shape and dimension. However, it is understood that other methods of creating the model 12 can be used, such as creating a virtual model on a computer, for example, without departing from the scope and spirit of the invention.

If a physical model if first created, a second step involves taking dimensional measurements of the physical model 14. The measurements of the model 14 can be taken either manually or electronically and recorded such as into a computer or to paper, for example. In the case of a computer generated model, this step can be eliminated.

Once recorded, the measurements of the model 14 are converted to mathematical coordinates 16, which are used to represent the model in space. In the preferred embodiment, the coordinates are converted using a CAD system, although other methods may be used, such as manually drawing the model using the measurements, for example. The resulting representation is a replica of the model of the desired final shape.

The fourth step in the method is to design a part 18 based on the desired final shape using the mathematical coordinates obtained in the previous step. The part may include additional components, such as a flexible plastic layer, a rigid substrate or reinforcement, and a flexible foam or pad filler, for example.

Next, a mathematical model of a visible surface of the part is produced 20. This is accomplished by using the CAD system to illustrate the visible surface and possibly the optional substrate and the filler as an entity in three dimensions.

The sixth step involves using the mathematical model of the previous step to design a first mold having a manipulated or distorted surface 22. The distorted surface of this step represents the class A or visible surface of the part distorted to facilitate molding of a flexible plastic layer thereupon. In essence, surfaces which may be difficult to reach using conventional molding techniques are distorted or manipulated, which may include inverting or angling the surface, for example, to make the surface more visible and accessible. In one embodiment, the first mold surface is developed using a CAD system. However, it is understood that the conversion could also be accomplished manually. The use of the computer facilitates a more efficient process. The specific manipulation or distortion of the visible surface of the part depends upon the exact geometry of the final part. The method of manipulation involves revising an angle of intersecting surfaces, while maintaining the remaining geometry of the original configuration of the part. By using the computer, numerous distorted models can be examined and attempted in order to reach a nominal design for the mold.

A seventh step preferably involves design of a second mold having a non-manipulated or non-distorted surface 24. The non-distorted surface represents the desired final configuration of the part. The second mold may be used to reposition the distorted part produced using the first mold. In addition, the second mold restrains the part reinforcement or substrate by being a negative reproduction of the second surface of the substrate.

Once the mold designs are complete, steps eight and nine involve producing the first mold 26 and the second mold 28. Typically, numerically controlled machines can be used to produce cutter paths for forming the first mold and the second mold. The numerically controlled machines can directly use the data created in the CAD system during the design steps to produce the molds. It is understood that the molds can also be produced manually using standard mold building techniques, with the data generated by the CAD system as well, without departing from the scope and spirit of the invention. The molds can be constructed of any conventional mold materials, such as aluminum, zinc, steel, electroplated metals such as nickel and copper, and polymer based materials such as silicone and epoxy, for example.

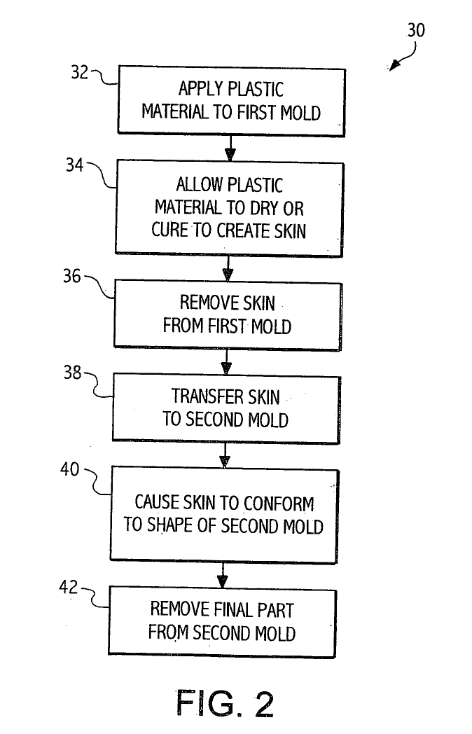

After the production of the molds is complete, in the final step in the method, the production of the part 30 can be accomplished. FIG. 2 is a flow diagram of illustrating a production process using the mold produced according to the method described above and illustrated in FIG. 1. To produce the part, plastic is applied to the first mold 32. The parts can be produced by any conventional manufacturing process such as injection molding, spraying polyurethane, slush molding, heat shaping, or rotocasting/rotational molding of thermoplastics such as PVC, TPU and TPO, for example. Thermoplastics may also be applied using a plasma deposition process.

Once the plastic has been applied, the plastic is allowed to dry, cool, or cure to create a skin 34. The skin is the plastic portion of the part. Once dried, cooled, and/or cured, the skin is removed from the first mold 36. The skin can then be optionally transferred to the second mold 38 having the desired final shape of the part. The skin is then caused to conform to the shape of the second mold 40. Additionally, the second mold may be used to laminate the substrate and/or reinforcement to the skin. This may be accomplished by any conventional method, such as by application of vacuum or pressure to the skin surface, for example. Once the final shape of the part has been reached, the final part is removed from the second mold 42. The part is now ready for transfer to other manufacturing or assembly processes. Alternatively, the skin may be manually conformed to its desired final shape. It is understood that the ordering of the above steps is not critical and that the order may be revised as desired.

The method steps as described eliminate steps of earlier manufacturing methods. By reducing the number of steps required for manufacturing the skins, cost is minimized and efficiency is maximized. Alternatively, the skin 34 can be manually warped or conformed to the desired final configuration without the use of the second mold 40.

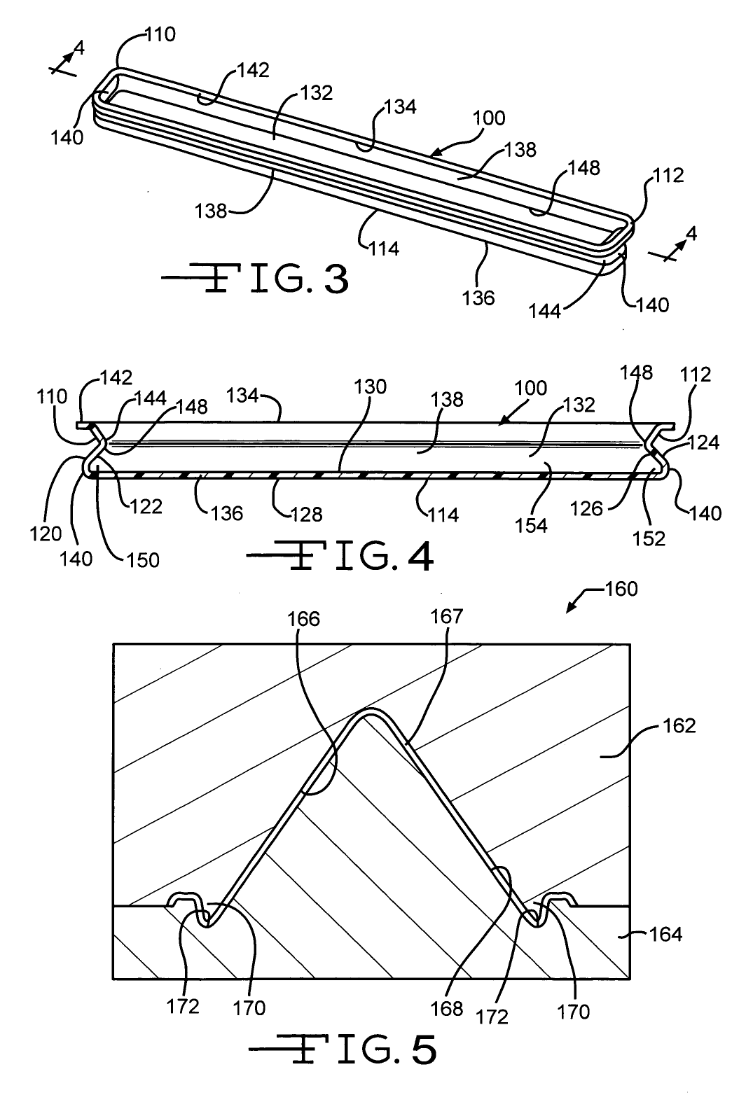

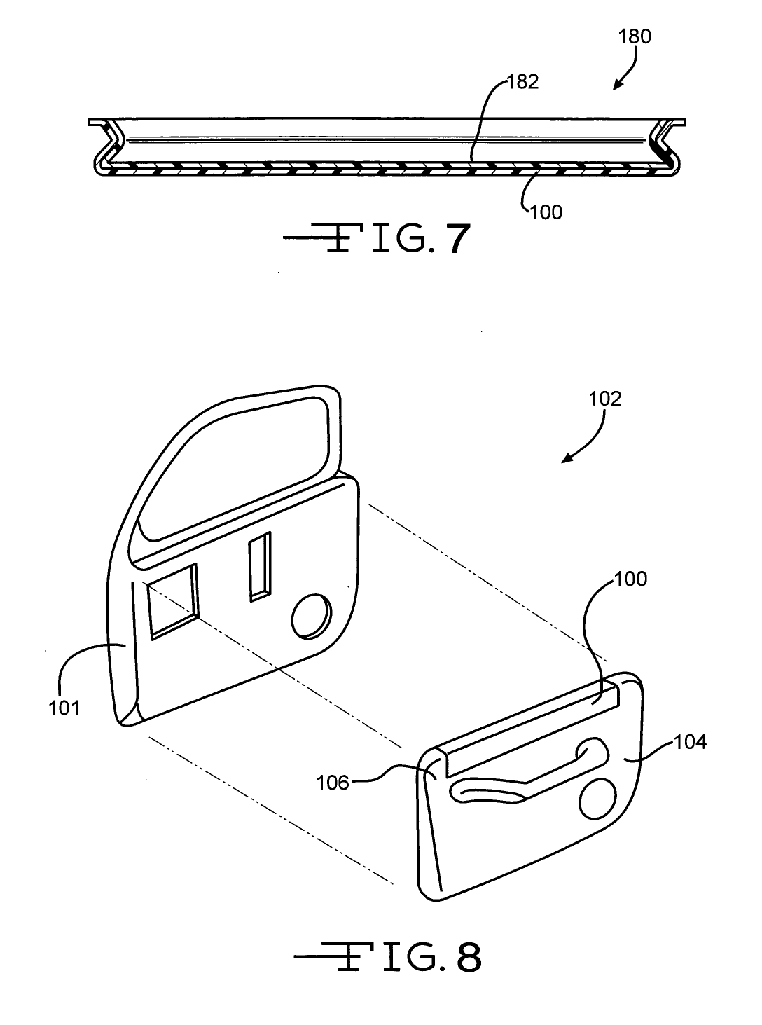

Referring to FIGS. 3 and 4, there is illustrated a part 100 which may be produced by an injection molding process as disclosed herein. Note that the shape of the part 100 is shown schematically and in simplicity in FIGS. 3 and 4 and may have any other desired shape. The part 100 may be formed from a relatively flexible plastic material. For example, there is illustrated in FIG. 8, a vehicle door assembly 102 including a door frame 101 and having a trim panel 104 mounted thereon. The part 100 may be used, for example, as an outer skin of an upper portion 106 of the trim panel 104. As will be explained below, the part 100 is preferably formed of a generally flexible or semi-flexible material and can be attached to a generally rigid substrate for supporting the part 100, thereby functioning as an aesthetically and tactile pleasing covering or skin of the substrate.

Referring to FIGS. 3 and 4, the illustrated part 100 is generally elongated in shape and includes a first end 110 and a second end 112 with an intermediate portion 114 therebetween. The first end 110 generally includes outer surface 120 and an inner surface 122. The second end 112 generally includes an outer surface 124 and an inner surface 126. The intermediate portion 114 generally includes opposed outer surfaces 128 and inner surfaces 130. If desired, any of the surfaces can be textured to provide an aesthetically and tactile pleasing surface, such as a faux leather grain pattern.

The part 100 can be formed from a plurality of relatively thin wall portions which define an open ended structure defining an interior 132 and an opening 134. For example, the part 100 may include a bottom wall 136, a pair of opposed side walls 138, and a pair of opposed end walls 140. The part 100 may also include a peripheral edge 142 defining the opening 134. Of course, the illustrated part 100 is only representative of one possible shape and the part 100 may include any number of wall portions having any desired shape.

The side walls 138 and end walls 140 include an indentation or recess 144 disposed between the peripheral edge 142 and the bottom wall 136. The recess 144 generally extends inwardly towards the interior 132 and defines an inwardly extending lip portion 148 facing the interior 132. Underneath the lip portion 148, as viewing FIG. 4, is a first pocket 150 formed in the first end 110 and a second pocket 152 formed in the second end 112. The recess 144 also defines third and fourth pockets 154 formed in the intermediate portion 114. It is noted that the first and second pockets 152 and 154 are generally covered or concealed by the lip portion 148 when viewing in a downward direction as shown in FIG. 4.

The method of producing the part 100 will now be explained with reference to FIGS. 5 through 8. A first preferred step of the method includes defining a first model of the part 100 having a first configuration. The first configuration generally relates to the desired final shape of the part 100, as shown in FIGS. 3 and 4. Preferably, the first model of the part 100 is a mathematical model of the part 100, such as rendered in computer aided design (CAD) programs. The measurements of the part 100 generally correspond with mathematical coordinates of the first model. Alternatively, the model may be physically created providing a representation of the desired final shape of the part 100. Dimensional measurements of the physical model can then be taken either manually or electronically and recorded such as into a computer or onto paper. These measurements of the model can then be converted to mathematical coordinates.

After the desired model of the part 100 is created or generated, the shape of desired model is manipulated from the first configuration, e.g., the desired final shape of the part 100, to a deformed or distorted shape corresponding to a second configuration. The second configuration is different from the first configuration. A mold assembly, such as the injection mold assembly 160 of FIG. 5 is produced corresponding to the distorted second configuration. The shape of the second configuration is preferably chosen to permit use of a relatively simple and non-complex mold assembly. The mold assembly 160 includes a first or upper mold 162 and a second or lower mold 164. The upper and lower molds 162 and 164 have opposed molding surfaces 166 and 168, respectively, formed therein defining a mold cavity 167. The mold cavity 167 generally corresponds to the shape of the part in its second configuration. As will be explained below, the mold assembly 160 is used for producing the part 100 but is formed in its distorted shape of the second configuration.

The molding surface 166 of the upper mold 162 generally corresponds to the shape of the inner surface 122 of the first end 110, the inner surface 126 of the second end 112, and the opposed inner surfaces 130 of the intermediate portion 114. The molding surface 168 of the lower mold 164 generally corresponds to the outer surface 120 of the first end 110, the outer surface 124 of the second end 112, and the opposed outer surfaces 128 of the intermediate portion 114. The upper mold 162 includes an extension portion 170 which cooperates with a recess portion 172 of the lower mold 164 to form the pockets 150, 152, and 154.

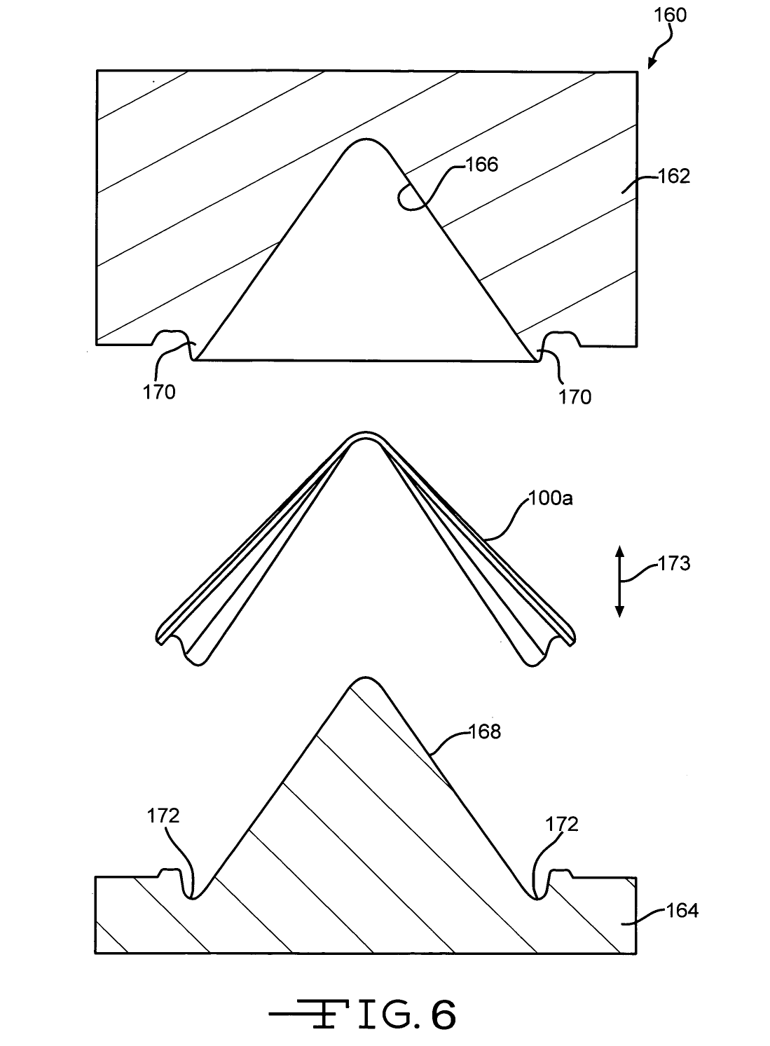

A material, such as molten plastic, is injected or otherwise injected into the molding cavities 166 and 168 to produce a part 100a (see FIG. 6) formed in the distorted shape of the second configuration. The part 100a may be cooled and then removed from the mold assembly 160. More specifically, the upper mold 162 and the lower mold 164 are moved away from each other in a linear mold direction, indicated generally at 173, as shown in FIG. 6. Note that the extension portion 170 may move away from the recess portion 172 in the mold direction without interference. In other words, the shape of the extension portion 170 and recess portion 172 are such that the extension portion 170 is not trapped within the recess portion 172 when the upper and lower molds 162 and 164 are separated from each other and moved in the liner mold direction 173. It can be seen from FIG. 4 that if the mold assembly 160 was designed corresponding the first configuration of the part 100, the corresponding extension and recess portions could not readily be moved relative to one another in the linear direction 173. Once the upper and lower molds 162 and 164 are separated, the part 100a may then be removed.

The part 100a is then conformed from the second configuration to the first configuration, thereby forming the part 100 to its final desired shape, as shown in FIGS. 3 and 4. The part 100a may be conformed be simply manually bending or positioning it from the second configuration to the first configuration if the part 100a is sufficiently flexible. Alternatively, the part 100a may be placed in a second mold assembly (not shown) to assist in deflecting or deforming the part 100a to the desired final shape.

The advantage of forming the part 100a in the distorted second configuration instead of the final desired shape is that a relatively simple mold assembly 160 having preferably just two molds 162 and 164 may be used. Directly molding the part 100 in its desired final shape in a conventional injection molding process in the past required a relatively complex mold assembly (not shown) having a plurality of moving mold elements due to the hidden features defined by the pockets 150, 152, and 154. A simple two-part mold assembly could not readily be used because the portions of the mold halves creating the pockets 150, 152, and 154 could not be separated from each other due to interference with one another. Instead, the conventional injection mold assembly would have required separate movable mold elements movably mounted within the mold halves. Addition of movable mold elements increases the cost of the mold assembly and may increase the production time in forming the part. After material is injected into the conventional mold assembly, the movable mold elements would need to be moved relative to the two mold halves in a direction different from the linear direction 173 to permit withdrawal of the portions of the molds forming the pockets. Although this conventional process can be used to form a part, the movable mold elements impart an unsightly parting line onto the injected molded part.

The above described method of the invention by injection molding the part 100a into a second configuration also has advantages over other conventional molding operations, such as slush molding and rotational deposition molding, in that tighter control of the dimensions of the part 100 are possible. Also, injection molding is generally more precise in imparting a textured surface, such as a faux leather grain pattern, on the part compared to slush molding or rotational deposition molding.

After the part 100 has been formed in its desired shape, the part 100 may be used individually or may be combined with other components to form a multi-layered panel, such as the trim panel 180 illustrated in FIG. 7. The trim panel 180 preferably includes the part 100 and a generally rigid substrate 182. The part 100 generally defines a cover or skin of the trim panel 180. The trim panel 180 can be formed by positioning the part 100 over the substrate 182. To assist in positioning the part 100 over the substrate 182, either or both the part 100 and substrate 182 can be temporarily deflected such that the part 100 fits over the substrate 182. The substrate 182 can be formed of a plastic material or any other suitable material. If the part 100 is relatively flexible having a relatively high elasticity, the rigid substrate 182 provides support for the part 100 which otherwise may not be sufficient to support itself in the final desired shape. If desired, other layers, such as a foam layer (not shown), may be included in the trim panel 180. For example, the substrate 182 and the part 100 may be positioned within a secondary mold assembly (not shown) in which a foam layer (not shown) is introduced between the part 100 and the substrate 182. The trim panel 180 may then be used, for example, as the upper portion 106 of the vehicle door assembly 102 of FIG. 8.

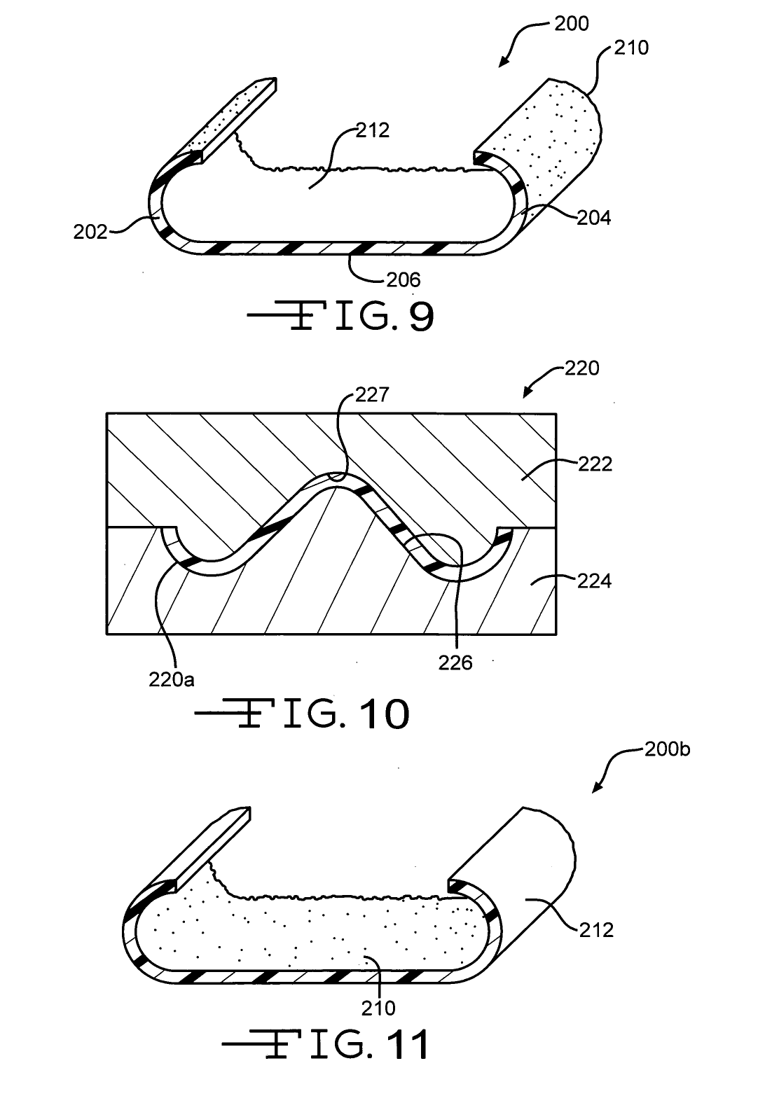

Referring to FIGS. 9 through 11, there is illustrated an alternate embodiment of a part 200 which may be produced in an injection molding process as disclosed herein. Similar to the method as described with respect to FIGS. 3 through 8, the part 200 may be formed by an injection molding process in which the part is injection molded into a configuration different than its desired final shape.

The part 200 includes a curved first end 202 and a curved second end 204 with an intermediate portion 206 therebetween. The part 200 includes an outer surface 210 which may include a textured surface, such as a faux leather grain pattern. The part 200 further includes an inner surface 212 which may not include a textured surface. The part 200 may be used as a trim panel or other vehicle component and can be combined with a substrate (not shown) to form a multi-layered trim panel assembly similar to the trim panel 180 described above. Thus, the textured outer surface 210 can be defined as a viewable class-A surface of a trim panel, wherein the inner surface 212 is hidden from normal viewing.

The part 200 illustrated in FIG. 9 corresponds to a desired final shape having a final configuration. A first model of the part 200 is created and then manipulated to provide a second or distorted model having a second configuration different from the first configuration. As shown in FIG. 10, a mold assembly 220 is used to form the part 200 in its second configuration. Similar to the mold assembly 160 described above, the mold assembly 220 includes a first upper mold 222 and a second lower mold 224 defining a molding cavity 226 therebetween. The upper mold 222 includes a textured surface 227 corresponding to the outer surface 210. The lower mold 224 has a shape corresponding to the inner surface 212. Material is injected into the molding cavity 226 to form a part 200a in the second configuration, as shown in FIG. 11. The part 200a can then be removed from the mold assembly 220 and then conformed into a part 200b, as shown in FIG. 11, having an intermediate configuration different from the final and second configurations. The part 200a can then be warped or conformed such that the curved ends 202 and 204 are deflected in an inside-out type of deformation to form the part 200 as shown in FIG. 9. An advantage of this method is that parts having complex shapes which generally would require movable mold elements imparting an undesirable parting line on the textured surface 210 of the part can be formed in an inside out type of configuration such that the mold assembly 220 does not impart a parting line of the exposed textured surface.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A method of producing a part comprising the steps of:
(a) defining a desired model of a part having a first configuration;
(b) mathematically manipulating the desired model to provide a distorted model defining a second configuration that is different from the first configuration;
(c) producing a mold assembly having a shape that corresponds with the second configuration;
(d) applying a material to the mold assembly to produce a part having the second configuration; and
(e) conforming the part to the first configuration corresponding to the desired model.

2. The method of claim 1, wherein the mold assembly is an injection mold assembly including first and second molds defining a cavity therebetween corresponding to the first configuration, and wherein in step (d) the material is injected into the cavity.

3. The method of claim 2, wherein the mold assembly includes only a first mold and a second mold, and wherein prior to step (e) the first mold is moved in a single linear direction away from the second mold to expose the part permitting the part to be removed from the mold assembly.

4. The method of claim 1, wherein in step (e), the part is conformed by manually deforming the part from the second configuration to the first configuration.

5. The method of claim 1, wherein in step (e), the part has a relatively high elasticity and is attached to a rigid substrate to form a trim panel, wherein the substrate provides support for the part.

6. The method of claim 5, wherein the substrate includes an end portion disposed within a pocket formed in the part.

7. The method of claim 1, wherein the trim panel is attached to a vehicle door frame.

8. The method of claim 1, wherein the part forms a portion of a vehicle interior trim panel.

9. The method of claim 1, wherein the material is applied to the mold assembly in step (d) by gun spraying.

10. The method of claim 1, wherein the material is applied to the mold assembly in step (d) by a gun spraying process.

11. The method of claim 1, wherein the material is applied to the mold assembly in step (d) by a slush molding process.

12. The method of claim 1, wherein the material is applied to the mold assembly in step (d) by a heat shaping process.

13. The method of claim 1, wherein the material is applied to the mold assembly in step (d) by a rotational molding process.

14. The method of claim 1, wherein the desired model is mathematically manipulated in step (b) using a computer.

15. The method of claim 1, wherein in step (a) the desired model is defined by creating a physical model and measurements of the physical model are taken, and wherein the measurements are converted to mathematical coordinates to represent the desired model.

16. A method of producing a part comprising the steps of:
(a) defining a desired model of a part having a first configuration;
(b) manipulating the desired model to provide a distorted model defining a second configuration that is different from the first configuration;
(c) producing an injection mold assembly having a cavity that corresponds with the second configuration;
(d) injecting material into the cavity of the mold assembly to produce a part having the second configuration; and
(e) conforming the part to the first configuration corresponding to the desired model.

17. The method of claim 1, wherein the mold assembly includes first and second molds defining the cavity therebetween.
